(19) United States
(12) Patent Application Publication
(10) Pub. No.: US 2014/0202593 A1
(43) Pub. Date: Jul. 24, 2014

(54) DEVICE FOR FILLING A TANK OF A MOTOR VEHICLE

(71) Applicants: Damien Douteau-Poiroux, Marcilly S/Eure (FR); Francis Marteau, Vert (FR); Aurelien Nezondet, Chaudon (FR)

(72) Inventors: Damien Douteau-Poiroux, Marcilly S/Eure (FR); Francis Marteau, Vert (FR); Aurelien Nezondet, Chaudon (FR)

(73) Assignee: RENAULT s.a.s, Boulogne-Billancourt (FR)

(21) Appl. No.: 14/008,900

(22) PCT Filed: Mar. 28, 2012
(86) PCT No.: PCT/FR2012/050645

§ 371 Date: Mar. 28, 2014

(30) Foreign Application Priority Data
Mar. 31, 2011 (FR) 1152711

(51) Int. Cl. B67D 7/42

(52) U.S. Cl. CPC B67D 7/42
USPC 141/311 R

(57) ABSTRACT

A device to fill a tank of a motor vehicle with a liquid, for example for a selective catalytic reduction system, including a filling tube that includes a bottom end penetrating into the tank and a top end receiving the liquid to fill the tank. A ventilation duct includes an inlet end penetrating into a top portion of the tank, an outlet end penetrating into the tube near the top end, and a lower section located at a first structural level below the inlet and outlet ends. A stationary head-loss generating element places the lower section in communication with a cavity located at a second structural level below the first structural level.

The invention relates to a device that allows a motor vehicle tank to be filled. More specifically, the invention relates to a device designed to supply a urea-containing liquid to a motor vehicle catalytic converter.

In general, such a device comprises a tank intended to contain the liquid, such as the one described in document EP2131020 for example. According to common practice in this technical field, the tank is filled from the top. This type of filling is particularly suitable to pouring the liquid out gradually from a bottle directly into an opening made at the upper part of the tank. The air or other gases contained in the tank on top of the liquid then escape(s) through the opening, closely hugging the stream of liquid poured in the opposite direction.

This mode of filling is not suitable when the tank is not sufficiently accessible to allow it to be filled by pouring the liquid directly into the tank. This method of filling is also not suited to rapid filling of the tank when the stream of poured liquid does not leave enough space through the opening to allow the air or other gases contained in the tank to escape in the opposite direction to the flow.

It is an object of the invention to use a filling tube which has a lower end entering a lower part of the tank and an upper end to take the liquid, thus allowing the tank to be filled from a distance. The tube for filling the tank from the bottom avoids the creation of a weak spot which would result, for example, from a piercing of the sheet metal.

There is therefore provided a vent duct which comprises an inlet end entering an upper part of the tank and an outlet end entering the tube near the upper end, so that any liquid that has inadvertently risen up inside the vent duct is collected near the end of the tube that is designed to take the liquid.

Such an arrangement does, however, present problems when manufacturing considerations dictate that the vent duct has to run alongside the filling tube, notably with a view to minimizing the space required and the complexity of mounting the device, for example, in a motor vehicle. Having the duct and the tube running alongside one another in this way causes the creation of a siphon in which the liquid has a tendency to accumulate as a result of an overspill, condensation, or other phenomena.

Fuel tank solutions have already been sought in the past. Thus, document FR-A-2597034 proposes the introduction of a valve of the nonreturn valve type between the bottom part of the duct and a lower part of the tank so that the liquid can pass from the duct to the tank to empty the siphon without being able to pass in the opposite direction.

However, the known solutions present other problems. The complexity introduced from the fitting of the valve is a factor in the increased cost and risk of breakdown when, for example, the valve jams. Further, the valve is ill suited to the catalytic reduction liquids which are corrosive.

With a view to providing a solution to these problems, the subject of the invention is a device that allows a motor vehicle tank to be filled with a liquid by means of a filling tube and a vent duct. The filling tube has a lower end entering the tank and an upper end to take the liquid so as to fill the tank. The vent duct comprises an inlet end entering an upper part of the tank, an outlet end entering the tube near the upper end and a low section situated at a first structural level below the level of the inlet and outlet ends. The device is notable in that it comprises a fixed pressure drop generating element that causes said low section to communicate with a cavity situated at a second structural level below the level of said first structural level.

In particular, said cavity is a portion of the tank which is situated underneath said low section.

Also in particular, said cavity is a portion of the tube situated underneath said low section.

Advantageously, said fixed pressure drop generating element comprises a porous material.

Advantageously also, said fixed pressure drop generating element comprises a geometric restriction.

The device is of considerable use for a selective catalytic reduction system tank for an exhaust system converter.

The device is also of considerable use when said liquid with which the tank is filled contains urea.

The invention will be better understood with the aid of some exemplary embodiments of a device according to the invention, making reference to the attached drawings in which:

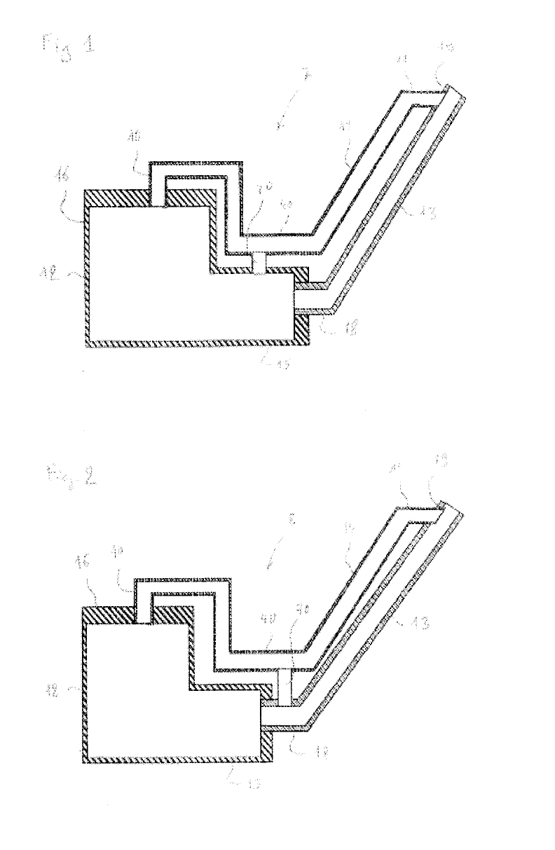

FIG. 1 is a view in cross section of a device according to the invention;

FIG. 2 is a view in cross section of another device according to the invention;

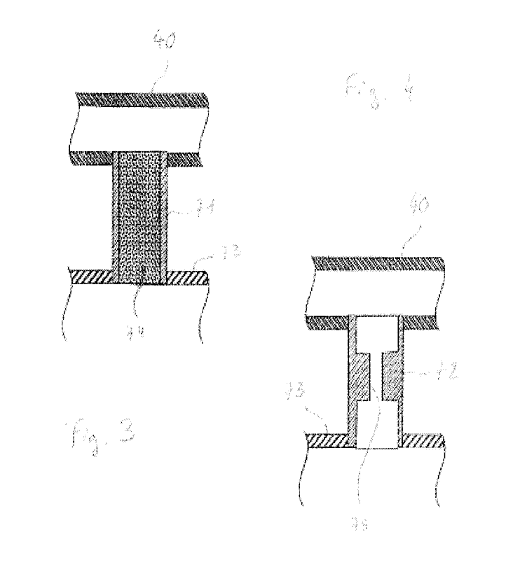

FIGS. 3 and 4 are views in cross section of a pressure drop generating element for implementing the invention.

FIGS. 1 and 2 show a device 7 and a device 8 for filling a tank 12 intended to supply a liquid to a component of a motor vehicle (not depicted). The motor vehicle component is notably an exhaust system converter.

The devices in FIGS. 1 and 2 are of particular use for a selective catalytic reduction exhaust system converter (often known by its English-language acronym “SCR” converter).

The tank 12 contains a reducing agent that reduces the oxides of nitrogen NOx emitted by an internal combustion engine (not depicted) of the vehicle. The reducing agent is, for example, a liquid containing a proportion of 30 to 35% urea diluted in demineralized water. A dose of liquid is generally taken from the tank 12 to be driven in a feed duct to an injector mounted on the exhaust system converter. The dose of liquid (NH2—CO—NH2) injected allows a predetermined quantity of nitrogen monoxide and nitrogen dioxide emitted by the engine to be converted chiefly into water (H2O) and nitrogen (N2). A tank 12 with a capacity of twenty liters generally gives the vehicle an autonomy of 20 000 km in terms of its ability to combat pollution.

In order to fill the tank 12 when its contents have all been consumed, a filling tube 13 comprises a lower end 18 entering a lower part 15 of the tank 12 and an upper part 19 to take the liquid, from a service station pump nozzle or from a can.

To vent the gases, notably air, sitting on top of the liquid in order to allow the level in the tank to rise, the device is equipped with a vent duct 14 which comprises an inlet end 10 entering an upper part 16 of the tank 12 and an outlet end 11 entering the tube 13 near the upper end 19. The rising up the duct 14 at the top of the filling tube causes the filling station nozzle to trip in the event of overflow.

The devices 7, 8 each constitute an accessory of use in the adding of liquid to a component of a vehicle, notably with a view to combating pollution. With a view to losing the least possible useful volume and to intervening on the structure, notably the bodywork, of the vehicle as little as possible, the vent duct 14 runs near the exterior surface of the tank 12 until it is near the lower end 18 of the tube 13, then runs along the tube 13 to meet it near its upper end 19.

In that way, just one passage in the structure of the vehicle is enough both for the filling tube 13 and for the vent duct 14. In addition, the duct 14 does not pass through any space in the vehicle other than the space occupied by the tank 12 and the tube 13, thus having minimal encroachment on the useful volume of the vehicle.

The advantage afforded by the geometry of the duct 14 that has just been described, in terms of minimizing the impact on the structure and useful volume of the vehicle, thus, however, has the downside of requiring, in the path of the duct 14, a low section 40 near the lower end 18 of the tube 13. Situating the low section 40 at a structural level that is lower down than its inlet and outlet ends 10, 11 has the effect of creating a siphon in which liquid can accumulate, for example at the end of the filling of the tank 12 after liquid has risen up the duct 14.

The presence of liquid in the low section 40 has the disadvantage of creating a dam preventing gases from being discharged in a subsequent filling operation. In addition, when the device 7 or 8 is subjected during operation to temperatures that drop below a threshold at which the liquid freezes, the solidification of the liquid in the low section 40 carries the risk of damaging the duct 14. The solidification of the liquid also creates a hard plug preventing gases from circulating along the duct 14. This disadvantage is crucial when the liquid contains urea, because the temperature at which urea freezes is −11° C., which is a temperature often encountered in the colder regions of the globe.

The devices 7 and 8 now explained with reference to FIGS. 1 to 4 offer the advantage of a simple and effective solution which relies on a fixed pressure drop generating element 70, 71, 72. The pressure drop generating element causes the low section 40 to communicate with a cavity 73 situated at a second structural level that is below the first structural level mentioned previously.

The pressure drop generating element 70 in FIG. 1 causes the low section 40 to communicate with a portion 15 of the tank 12 which is situated underneath the low section 40. The portion 15 of the tank 12 here constitutes the cavity referenced 73 in FIGS. 3 and 4.

The pressure drop generating element 70 in FIG. 2 causes the low section 40 to communicate with a portion 18 of the tube 13 situated underneath the low section 40. The portion 18 of the tube 13 here constitutes the cavity referenced 73 in FIGS. 3 and 4.

The fixed pressure drop generating element referenced 70 in FIGS. 1 and 2 is depicted in greater detail in FIGS. 3 and 4 where it is referenced 71 in FIGS. 3 and 72 in FIG. 4.

With reference to FIG. 3, the pressure drop generating element contains a porous material 74.

With reference to FIG. 4, the pressure drop generating element comprises a geometric restriction 75.

The pressure drop generated by the porous material or the geometric restriction is fixed in the sense that no moving part such as valves are involved and in that it can be determined in a constant way according to the geometric dimensions (porosity and size of the porous material, diameter and length of the restriction).

The device 7 or 8 cycles in the main through four customary operating states. In a first state that corresponds to the tank 12 being practically empty, the liquid level in the tank 12 is below the structural level of the low section 40. In a second state corresponding to the filling of the tank 12, the liquid level in the tank 12 rises gradually above the structural level of the low section 40 until it reaches the upper part 16. In the state during which the device 7 or 8 is being filled, there is a risk that liquid will accumulate in the low section 40. In a third state that corresponds to a nearly full tank 12, the liquid level in the tank 12 is near the inlet end 10 of the vent duct 14. In a fourth state that corresponds to the tank 12 being emptied, the liquid level in the tank 12 drops gradually below the structural level of the low section 40 until it returns to the first state.

Under driving conditions, when the level of liquid in the tank is low enough for the part of the element 70 on the cavity side, in other words on the same side as the tank 12 or on the same side as the tube 13, is no longer in contact with liquid in the tank or in the tube 13, the depression thus created at the base of the element 70 causes liquid contained in the low section 40 to flow toward the cavity 73.

A filling can therefore be performed chiefly when the level of liquid in the tank 12 or in the tube 13 is low enough to trigger emptying of the siphon formed by the low section 40. This low level can usefully be made to coincide with an indication displayed on the vehicle instrument panel. For example, for a liquid that constitutes a reducing agent for the emissions of toxic gases in an exhaust system convertor, emissions control regulations as applicable to vehicles that have been homologated as SCR vehicles dictate that the driver need not be alerted to the need to fill the tank 12 until the remaining autonomy is just 2400 km.

A capillary section of the porosities 74 or of the restriction 75, combined with a low level of pressure in the filling tube 13, considerably slows, during the tank-filling phase, the passage of liquid via the element 70 from the tank 12 to the duct 14.

The geometric dimensions of the element 70, 71, 72 are determined either by calculation or by testing or by a combination of calculation and testing according to the filling flow rate and the shape of the tank and of the siphon so that the time taken to fill the tank 12 is strictly below the time taken to fill the siphon formed by the low section 40 as liquid rises up through the element 70. This is enough to prevent the vent duct 14 from becoming filled via the element 70 before the end of filling.

The porous material is, for example, an open-cell foam or a heap of microbeads retained in a strainer.

The restriction is, for example, a single restriction or made up of a number of restrictions arranged in series or in parallel.

1-7. (canceled)

8. A device for filling a motor vehicle tank with a liquid, comprising:
a filling tube including a lower end entering the tank and an upper end to take the liquid to fill the tank; and
a vent duct including an inlet end entering an upper part of the tank, an outlet end entering the tube near the upper end, and a low section situated at a first structural level below a level of the inlet and outlet ends;
a fixed pressure drop generating element that causes the low section to communicate with a cavity situated at a second structural level below the level of the first structural level.

9. The device as claimed in claim 8, wherein the cavity is a portion of the tank situated underneath the low section.

10. The device as claimed in claim 9, wherein the cavity is a portion of the tube situated underneath the low section.

11. The device as claimed in claim 8, wherein the fixed pressure drop generating element comprises a porous material.

12. The device as claimed in claim 8, wherein the fixed pressure drop generating element comprises a geometric restriction.

13. The device as claimed in claim 8, wherein the tank is a selective catalytic reduction system tank for an exhaust system converter.

14. The device as claimed in claim 8, wherein the liquid with which the tank is filled contains urea.
